(19) United States
(12) Patent Application Publication
(10) Pub. No.: US 2011/0276241 A1
(43) Pub. Date: Nov. 10, 2011

(54) CONTROL APPARATUS FOR POWER TRANSMITTING SYSTEM OF FOUR-WHEEL-DRIVE VEHICLE

(75) Inventor: Michiaki Nakao, Aichi (JP)

(73) Assignee: Toyota Jidosha Kabushiki Kaisha, Toyota-shi (JP)

(21) Appl. No.: 13/143,853

(22) PCT Filed: Jan. 8, 2009
(86) PCT No.: PCT/JP2009/050159

§ 371 Date: Jul. 8, 2011

(51) Int. Cl. B60K 17/34; B60K 6/445; B60K 6/52; B60W 20/00; B60W 10/06; B60W 10/08; B60W 10/12; B60K 6/22; B60K 17/348

(52) U.S. Cl. 701/69; 477/2; 477/3; 475/5; 180/65.21; 903/902

(57) ABSTRACT

A control apparatus for a power transmitting system of a four wheel-drive vehicle, which includes a first drive power source, a second drive power source, and a central differential mechanism disposed between the first and second drive power sources. The central differential mechanism has an input rotary element and a pair of output rotary elements and is constructed to distribute an output of the first drive power source received by the input rotary element, to the pair of output rotary elements to transmit the output of the first drive power source to front wheels and rear wheels of the vehicle. The second drive power source is disposed in a power transmitting path between one of the pair of output rotary elements and the front or rear wheels. The control apparatus includes a coupling device disposed between the pair of output rotary elements, and drive force distribution changing unit which changes drive force distribution to the pair of output rotary elements by changing a drive force generated by the second drive power source and an engaging capacity of the coupling device.

### TECHNICAL FIELD

The present invention relates to a control apparatus for a power transmitting system of a four-wheel-drive vehicle, and more particularly to techniques for improving freedom of distribution of a vehicle drive force.

### BACKGROUND ART

There is known a power transmitting system of a four-wheel-drive vehicle, which includes a first drive power source, a second drive power source, and a central differential mechanism disposed between the first and second drive power sources, and wherein the central differential mechanism has an input rotary element and a pair of output rotary elements and is constructed to distribute an output of the first drive power source received by the input rotary element, to the pair of output rotary elements to transmit the output of the first drive power source to front wheels and rear wheels of the vehicle, while the second drive power source is disposed in a power transmitting path between one of the pair of output rotary elements and the front or rear wheels. Patent document 1 discloses a hybrid vehicle drive system, which is an example of such a power transmitting system as described above. This patent document discloses a technique for reducing the length of the vehicle in its longitudinal direction, by disposing the central differential mechanism (power distribution mechanism) between the first drive power source and the second drive power source in the longitudinal direction of the vehicle.

Patent Document 1: JP-2004-114944 A

### DISCLOSURE OF THE INVENTION

In the four-wheel-drive vehicle power transmitting system arranged as described above, a drive force of the second drive power source is transmitted to only one of the pair of output rotary elements, and is not transmitted to the other output rotary element. Thus, this four-wheel-drive vehicle power transmitting system has a problem of a relatively low degree of freedom of drive force distribution, and therefore does not permit suitable drive force distribution according to a running condition of the vehicle, giving rise to a problem of insufficient drivablility of the vehicle.

It is an object of the present invention to provide a control apparatus for a power transmitting system of a four-wheel-drive vehicle, which permits an improved degree of freedom of drive force distribution, for suitable drive force distribution of the power transmitting system .

### Means for Achieving the Object

The object indicated above is achieved according to the present invention defined in claim 1, which provides a control apparatus for a power transmitting system of a four-wheel-drive vehicle, which includes a first drive power source, a second drive power source, and a central differential mechanism disposed between the above-indicated first and second drive power sources, and wherein the central differential mechanism has an input rotary element and a pair of output rotary elements and is constructed to distribute an output of the first drive power source received by the input rotary element, to the pair of output rotary elements to transmit the output of the first drive power source to front wheels and rear wheels of the vehicle, while the second drive power source is disposed in a power transmitting path between one of the pair of output rotary elements and the above-indicated front or rear wheels, the control apparatus being characterized by comprising: a coupling device disposed between said pair of output rotary elements; and drive force distribution changing means for changing drive force distribution to the above-indicated pair of output rotary elements, by changing a drive force generated by the above-indicated second drive power source and an engaging capacity of the above-indicated coupling device.

According to the invention defined in claim 2, the control apparatus is characterized in that the above-indicated drive force distribution changing means changes the drive force distribution to the above-indicated pair of output rotary elements, by further changing a drive force generated by the above-indicated first drive power source.

According to the invention defined in claim 3, the control apparatus according to claim 1 or 2 is further characterized in that the above-indicated first drive power source comprises: an engine; a differential electric motor; and a differential gear device constructed to distribute an output of the engine to the differential electric motor and the above-indicated input rotary element, and functions as an electrically controlled continuously variable transmission capable of continuously changing a speed ratio of the engine with respect to the input rotary element while an operating state of the differential electric motor is controlled.

According to the invention defined in claim 4, the control apparatus according to any one of claims 1-3 is further characterized in that the above-indicated second drive power source is an electric motor.

### Advantages of the Invention

In the control apparatus according to the invention defined in claim 1 for the power transmitting system of the four-wheel-drive vehicle, the drive force distribution changing means is configured to change the drive force distribution to the above-indicated pair of output rotary elements, by changing the drive force generated by the above-indicated second drive power source and the engaging capacity of the above-indicated coupling device, so that a portion of the drive force generated by the above-indicated second drive power source is transmitted to the other of the pair of output rotary elements through the partial (slipping) engagement of the above-indicated coupling device. Further, the drive force distribution changing means makes it possible to improve the freedom of the drive force distribution to the above-indicated front and rear wheels, by changing the drive force generated by the above-indicated second drive power source, as well as the engaging capacity of the above-indicated coupling device.

In the control apparatus according to the invention defined in claim 2 for the power transmitting system of the four-wheel-drive vehicle, the drive force distribution changing means changes the drive force distribution to the above-indicated pair of output rotary elements, by further changing the drive force generated by the first drive power source, making it possible to further improve the freedom of the drive force distribution to the above-indicated front and rear wheels.

In the control apparatus according to the invention defined in claim 3 for the power transmitting system of the four-wheel-drive vehicle, the above-indicated first drive power source comprises: an engine; a differential electric motor; and a differential gear device constructed to distribute an output of the engine to the differential electric motor and the above-indicated input rotary element, and functions as an electrically controlled continuously variable transmission capable of continuously changing a speed ratio of the engine with respect to the input rotary element while an operating state of the differential electric motor is controlled. Accordingly, the drive force transmitted to the above-indicated input rotary element can be continuously changed.

In the control apparatus according to the invention defined in claim 4 for the power transmitting system of the four-wheel-drive vehicle, the above-indicated second drive power source is an electric motor, so that the drive force of the second drive power source can be continuously changed.

The control apparatus is preferably configured to set a drive force distribution to the front and rear wheels, on the basis of a front wheel drive force ratio or a rear wheel drive force ratio which is predetermined according to a running condition of the vehicle, so that the engaging capacity of the coupling device, the drive force of the first drive power source and the drive force of the second drive power source are controlled on the basis of the predetermined front or rear wheel drive force ratio, for suitably controlling the drive force distribution of the vehicle.

### BRIEF DESCRIPTION OF THE DRAWINGS

FIG. 1 is a view schematically showing a power transmitting system of a four-wheel-drive vehicle according to one embodiment of this invention.

FIG. 2 is a schematic view showing a portion of the power transmitting system of FIG. 1, that is, a portion including a first drive power source, a central differential mechanism, a rear wheel drive output shaft, a front wheel drive output shaft, a second drive power source and an automatic transmission.

FIG. 3 is a view illustrating input and output signals of an electronic control device provided for the four-wheel-drive vehicle power transmitting system of FIG. 1.

FIG. 4 is a functional block diagram showing major control functions of the electronic control device, which functions as a control device for controlling the power transmitting system.

FIG. 5 is a power flow chart indicating a torque transmission relationship of a power source device consisting of the first and second drive power sources.

FIG. 6 is a power flow chart indicating a torque transmission relationship of the first drive power source and a clutch device.

FIG. 7 is a power flow chart indicating a torque transmission relationship of the second drive power source and the clutch device.

FIG. 8 is a flow chart illustrating one of the major control functions of the electronic control device, namely, an operation to calculate a torque that should be transmitted from the clutch device.

### EXPLANATION OF REFERENCE SIGNS

10: Four-wheel-drive vehicle power transmitting system
12: First drive power source
13: Second drive power source
14: Front wheel drive output shaft (pair of output shafts)
16: Rear wheel drive output shaft (pair of output shafts)
18: Front wheels
20: Rear wheels
22: Central differential mechanism
41: Clutch device (Coupling device)
42: Engine
44: Differential gear device
46: Power transmitting member (Input rotary element)
64: Drive power distribution changing means
MG1: First electric motor (Differential electric motor)
MG2: Second electric motor (Electric motor)

### BEST MODE FOR CARRYING OUT THE INVENTION

The embodiment of this invention will be described in detail by reference to the drawings. It is to be understood that the drawings showing the embodiment described below are simplified or drawn schematically, and do not accurately represent the dimensions and shapes of the elements of the embodiment.

### Embodiment

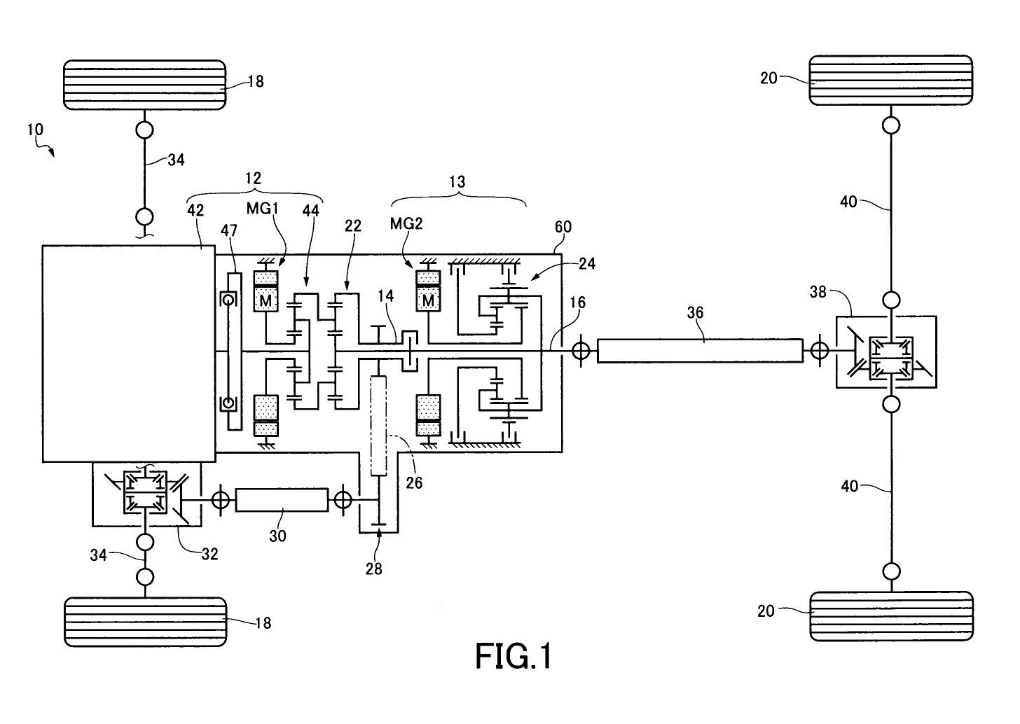

FIG. 1 is the view showing a power transmitting system 10 for a four-wheel-drive vehicle (hereinafter referred to as “power transmitting system 10”). As shown in FIG. 1, the power transmitting system 10 includes a first drive power source 12 provided as a main drive power source of the four-wheel-drive vehicle, a central differential mechanism 22 operatively connected to the first drive power source 12 and constructed to distribute an output of the first drive power source 12 to its front wheel drive output shaft 14 and its rear wheel drive output shaft 16 to transmit the output of the first drive power source 12 to front wheels 18 and rear wheels 20, and a second drive power source 13 connected to a power transmitting path between the rear wheel drive output shaft 16 and the rear wheels 20. Between the front wheel drive output shaft 14 and the rear wheel drive output shaft 16, there is disposed a coupling device in the form of a clutch device 41. It is to be understood that the front wheel drive output shaft 14 serves as one of a pair of output rotary elements of the central differential mechanism 22, while the rear wheel drive output shaft 16 serves as the other of the pair of output rotary elements.

A drive force (torque) transmitted to the front wheel drive output shaft 14 is transmitted to the pair of (right and left) front wheels 18 through a pair of power transmitting gears 28 connected to each other by a chain 26, a front wheel drive propeller shaft 30, a front wheel drive differential gear device 32, and a pair of (right and left) front wheel drive shafts 34. On the other hand, a drive force (torque) transmitted to the rear wheel drive output shaft 16 is transmitted to the pair of (right and left) rear wheels 20 through a rear wheel drive propeller shaft 36, a rear wheel drive differential gear device 38, and a pair of (right and left) rear wheel drive shafts 40. The rear wheel drive output shaft 16 receives the drive forces from the first drive power source 12 and the second drive power source 13.

The first drive power source 12 described above includes an engine 42, a damper device 47 provided to reduce a rotary motion variation of the engine 42, a first electric motor MG1 (differential electric motor), and a differential gear device 44 arranged to distribute an output of the engine 42 to the first electric motor MG1 and the central differential mechanism 22 (to a carrier CA2 described below). On the other hand, the second drive power source 13 includes a second electric motor MG2 (electric motor), and an automatic transmission 24 arranged to change an operating speed of the second electric motor MG2.

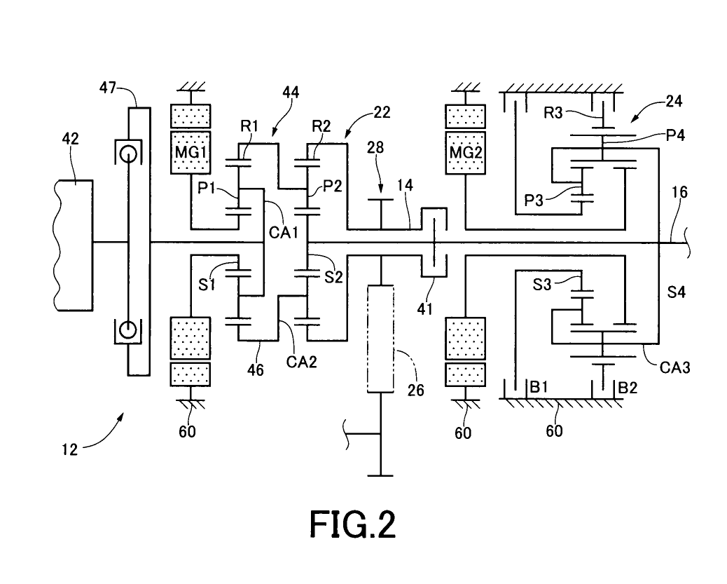

FIG. 2 is the schematic view showing a portion of the power transmitting system 10 of FIG. 1, that is, a portion including the first drive power source 12, central differential mechanism 22, rear wheel drive output shaft 14, front wheel drive output shaft 16, second drive power source 13 and automatic transmission 24. As shown in FIG. 2, the output of the engine 42 is transmitted to the differential gear device 44 through the damper device 47, and the output of the engine 42 transmitted to the differential gear device 44 is distributed to the first electric motor MG1 and the central differential mechanism 22.

The differential gear device 44 described above is constituted by a planetary gear device of a single pinion type having a sun gear S1 connected to the first electric motor MG1, a carrier CA1 connected to an output shaft of the engine 42 through the damper device 47, and a ring gear R1 operatively connected to the central differential mechanism 22 (carrier CA2) through a power transmitting member 46 which serves as an input rotary element.

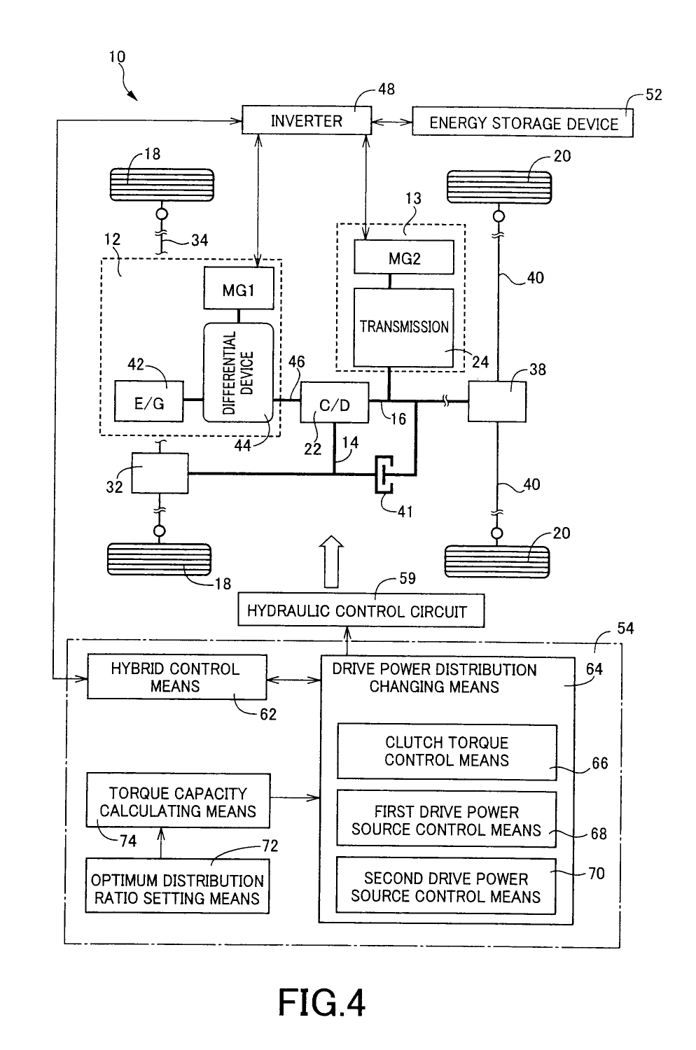

The engine 42 described above is an internal combustion engine such as a gasoline engine or a diesel engine. Operating conditions of this engine 42 such as an angle of opening of a throttle valve or an intake air quantity, an amount of supply of a fuel, an ignition timing and so on are electrically controlled by an electronic control device 54 described below and shown in FIG. 4, which is principally constituted by a microcomputer, for example. The electronic control device 54 is configured to receive output signals of an accelerator operation amount sensor, a sensor to detect the angle of opening of a throttle valve, a vehicle speed sensor, a first electric motor speed sensor, a second electric motor speed sensor, etc., which are not shown.

Each of the first and second electric motors MG1 and MG2 described above is a motor generator which functions selectively as an electric to generate a drive torque or an electric generator. As shown in FIG. 4, these first and second electric motors MG1 and MG2 are electrically connected through an inverter 48 to an electric energy storage device 52 such as a battery or capacitor. The inverter 48 is controlled by the electronic control device 54 shown in FIG. 4, to adjust the drive torque or regenerative braking torque of the first and second electric motors MG1 and MG2.

The first drive power source 12 constructed as described above functions as an electrically controlled continuously variable transmission capable of continuously change a speed ratio of the engine 42 and power transmitting member 46, while the operating state of the first electric motor MG1 is controlled. Described in detail, the rotating speed (operating speed) of the first electric motor MG1 is changed while the operating speed of the engine 42 is kept constant, for example, to continuously (not in steps) change the rotating speed of the power transmitting member 46. Alternatively, the operating speed of the first electric motor MG1 is changed while the rotating speed of the power transmitting member 46 is kept constant, to continuously (not in steps) change the operating speed of the engine 42.

The central differential mechanism 22 described above is constituted by a planetary gear device of a single pinion type having a sun gear S2 connected to the rear wheel drive output shaft 16, the carrier CA2 connected to a ring gear R1 of the differential gear mechanism 44 through the power transmitting member 46, and a ring gear R2 connected to the front wheel drive output shaft 14. This central differential mechanism 22 distributes an output of the first drive power source 12 received by the carrier CA2 to the ring gear R2 (front wheel drive output shaft 14) and the sun gear S2 (rear wheel drive output shaft 16), to transmit the output of the first drive power source 12 to the front and rear wheels 14, 16. The clutch device 41 disposed between the front and rear wheel drive output shafts 14, 16 is placed in a partially engaged state (slipping state) or a fully engaged state, to permit power transmission between the output shafts 14, 16.

In the present embodiment, a transfer device (drive power distributing device) is principally constituted by the central differential mechanism 22, front wheel drive output shaft 14, rear wheel drive output shaft 16, chain 26, and pair of power transmitting gears 28. This transfer device also includes the clutch device 41 which permits the power transmission between the front and rear wheel drive output shafts 14, 16. This clutch device 41 is constituted, for example, by a so-called frictional coupling device which generates a braking torque by friction and which is a hydraulically operated frictional coupling device of a wet multi-disc type having a plurality of mutually superposed friction plates that are forced against each other by a hydraulic actuator, or a band brake having one band or two bands which is/are wound on the outer circumferential surface of a rotary drum and tightened at one end of the band(s) by a hydraulic actuator. The clutch device 41 is selectively brought to its partially or fully engaged state to connect the two members between which the clutch device 41 is disposed, that is, to couple the front and rear wheel drive output shafts 14, 16 to each other. The pressure of the working oil of the hydraulic actuator (engaging pressure) of the clutch device 41 is controlled by a hydraulic control circuit 59 the operating state of which is changed under the control of the electronic control device 54 shown in FIG. 4, so that the torque capacity (engaging capacity) of the clutch device 41 is continuously variable according to the controlled pressure of the working oil. When the clutch device 41 is placed in its fully engaged state, the central differential mechanism 22 is placed in its non-differential state to distribute the received vehicle drive force evenly to the front and rear wheels 18, 20. When the clutch device 41 is placed in its partially engaged state (slipping state), the torque transmitted from the rear wheel drive output shaft 16 to the front wheel drive output shaft 14 is changed according to the engaging force of the clutch device 41.

The second drive power source 13 includes the second electric motor MG2 and the automatic transmission 24. The automatic transmission 24 is constituted by a pair of planetary gear mechanisms of a Ravigneaux type. That is, the automatic transmission 24 has a sun gear S3 selectively connected to a stationary member in the form of a housing 60 through a brake B1, a sun gear S4 connected to the second electric motor MG2, a carrier CA3 supporting a plurality of short pinion gears P3 and a plurality of long pinion gears P4 and connected to the rear wheel drive output shaft 16, and a ring gear R3 selectively connected to the housing 60 through a brake B2 and meshed with the plurality of long pinion gears P4. The short pinion gears P3 mesh with the sun gear S3, while the long pinion gears P4 mesh with the short pinion gears P3 and the sun gear S3. The carrier CA3 supports the short and long pinion gears P3, P4 such that each pinion gear P3, P4 is rotatable about its axis and about the axis of the rear wheel drive output shaft 16. The sun gear S3 and the ring gear R3 cooperate with the short and long pinion gears P3, P4 to constitute a planetary gear device of a double pinion type, while the sun gear S4 and the ring gear R4 cooperate with the long pinions P4 to constitute a planetary gear device of a single pinion type.

Like the clutch device 41, each of the brakes B1 and B2 is preferably constituted by a so-called frictional coupling device which generates a braking torque by friction and which is a hydraulically operated frictional coupling device of a wet multi-disc type having a plurality of mutually superposed friction plates that are forced against each other by a hydraulic actuator, or a band brake having one band or two bands which is/are wound on the outer circumferential surface of a rotary drum and tightened at one end of the band(s) by a hydraulic actuator. Each of the brakes B1, B2 is selectively brought to its engaged state to connect together the two members between which the brake B1, B2 is disposed. The pressure of the working oil of the hydraulic actuator (engaging pressure) of the brake B1, B2 is controlled by the hydraulic control circuit 59 the operating state of which is changed under the control of the electronic control device 54 shown in FIG. 4, so that the torque capacity (force of engagement) of the brake B1, B2 is continuously variable according to the controlled pressure of the working oil.

In the automatic transmission 24 constructed as described above, the sun gear S4 functions as an input element, while the carrier CA3 functions as an output element. When the brake B1 is placed in its engaged state, the automatic transmission 24 is placed in its high-speed position H having a speed ratio higher than 1. When the brake B2 is placed in its engaged state in place of the brake B1, the automatic transmission 24 is placed in its low-speed position L having a speed ratio higher than that of the high-speed position H. When the brake B1 and the brake B2 are both placed in their released states, the automatic transmission 24 is placed in its neutral position in which the power transmitting path through the automatic transmission 24 is disconnected. Thus, the automatic transmission 24 is a transmission mechanism the speed ratio of which is changed in steps by engaging and releasing actions of hydraulically operated frictional coupling devices.

The automatic transmission 24 is shifted, that is, switched between the high-speed position H and low-speed position L, on the basis of the vehicle running condition represented by the vehicle running speed, a value relating to a required (target) vehicle drive force, etc. Described in detail, the high-speed position H or low-speed position L to which the automatic transmission 24 should be shifted is determined on the basis of the vehicle running condition detected by various sensors and according to a stored map (which defines shifting lines) preliminary obtained by experimentation as a relationship between the vehicle running condition and the high-speed and low-speed positions H, L by the electric control device 54. The hydraulic control circuit 59 shown in FIG. 4 is commanded to control the pressures of the working fluid applied to the brakes B1 and B2 so as to establish the determined high-speed position H or low-speed position L. The electronic control device 54 receives output signals of an oil temperature sensor to detect the temperature of the working oil to actuate the brakes B1, B2, an oil pressure switch to detect the temperature of the working oil of the brakes B1, B2 and the clutch device 41, etc., in addition to the output signals of the sensors described above. The value relating to the required vehicle drive force is a required (target) value of the vehicle drive force, which is determined on the basis of the operation amount of an accelerator pedal (or the angle of opening of the throttle valve, intake air quantity, air/fuel ratio or amount of injection of the fuel), for example. However, the value relating to the required vehicle drive force may be replaced by the operation amount of the accelerator pedal per se, for example.

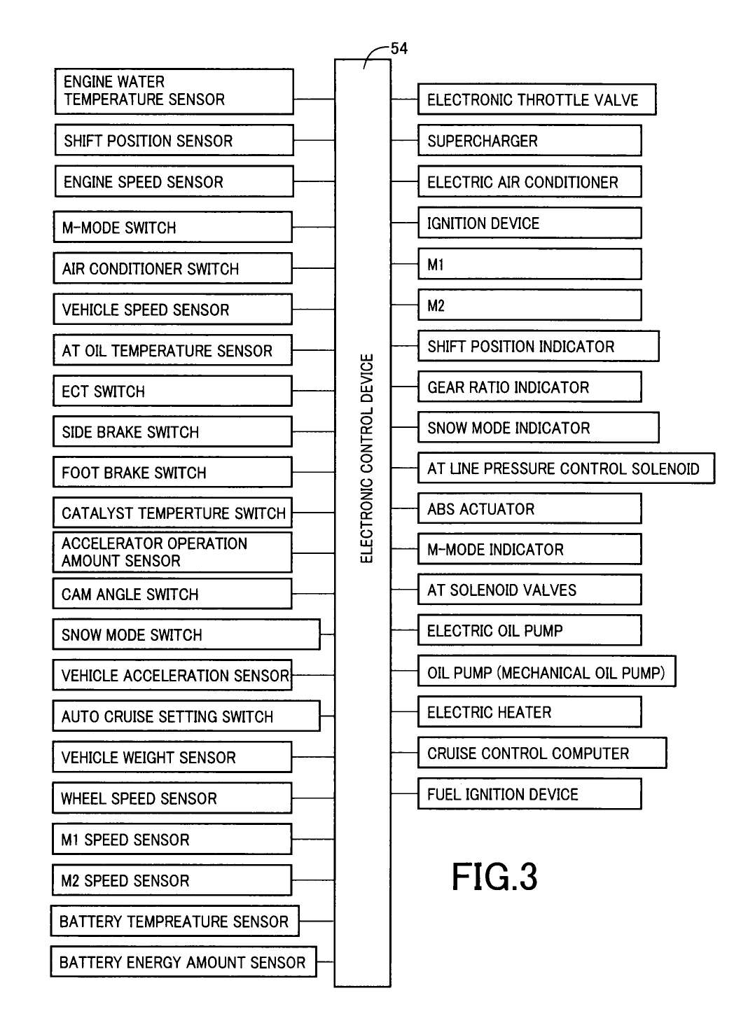

FIG. 3 illustrates the input signals received by and the output signals generated from the electronic control device 54 for controlling the present power transmitting system 10. This electronic control device 54 is principally constituted by a microcomputer incorporating a CPU, a ROM, a RAM, and an input-output interface, and is configured to perform signal processing operations according to control programs stored in the ROM while utilizing a temporary data storage function of the RAM, for executing hybrid drive controls of the engine 42, and the first and second electric motors MG1, MG2, and a shifting control of the automatic transmission 24.

The electronic control device 54 is arranged to receive, from the various sensors and switches shown in FIG. 3, various signals such as: a signal indicative of a temperature TEMP_{w} of engine cooling water; a signal indicate of a selected one of operating positions P_{SH} of a shift lever or the number of operations of the shift lever from an “M” position; a signal indicative of the operating speed N_{E} of the engine 42; a signal indicative of a value indicating the gear ratio; a signal indicative of an M mode (manual shifting mode); a signal indicative of the operating state of an air conditioner; a signal indicative of a vehicle running speed V corresponding to a rotating speed N_{OUT} of the output shaft (hereinafter referred to as “output shaft rotating speed N_{OUT}”); a signal indicative of a temperature T_{OIL} of the working oil of the automatic transmission 24; a signal indicative of the operating state of a side brake; a signal indicative of the operating state of a foot brake; a signal indicative of the temperature of a catalyst; a signal indicative of an angle A_{CC} of operation of the accelerator pedal which represents the amount of vehicle output required by the vehicle operator; a signal indicative of an angle of a cam; a signal indicative of the selection of a snow drive mode of the vehicle; a signal indicative of a longitudinal acceleration value G of the vehicle; a signal indicative of the selection of an auto-cruising mode of the vehicle; a signal indicative of the weight of the vehicle; signals indicative of the rotating speeds of the vehicle wheels; a signal indicative of an operating speed N_{M1} of the first electric motor MG1; a signal indicative of an operating speed N_{M2} of the second electric motor MG2; a signal indicative of an electric energy amount SOC stored in (charged state of) the electric energy storage device 52 (shown in FIG. 4); and a signal indicative of a temperature T_{BAT} of the electric energy storage device 52.

The electronic control device 54 is further arranged to generate various signals such as: control signals to be applied to an engine output control device to control the output of the engine, such as a drive signal to drive a throttle actuator for controlling the opening angle θ_{TH} of the electronic throttle valve disposed in an intake pipe of the engine 42, a signal to control the amount of injection of the fuel by a fuel injecting device into the intake pipe or the cylinders of the engine 42, a signal to be applied to an ignition device to control the ignition timing of the engine 42, and a signal to adjust the pressure of a supercharger, a signal to actuate the electrically operated air conditioner; signals to operate the first and second electric motors MG1 and MG2; a signal to operate a shift-position indicator for indicating the selected operating position of a shift lever; a signal to operate a gear-ratio indicator for indicating the gear ratio; a signal to operate a snow-mode indicator for indicating the selection of the snow drive mode; a signal to operate an ABS actuator for anti-lock braking of the vehicle; a signal to operate an M-mode indicator for indicating the selection of the M-mode; signals to operate solenoid-operated valves (linear solenoid valves) incorporated in the hydraulic control circuit 59 (shown in FIG. 4) provided o control the hydraulic actuators of the hydraulically operated frictional coupling devices of the clutch device 41 and the automatic transmission 24; a signal to operate a regulator valve incorporated in the hydraulic control circuit 59, to regulate a line pressure P_{L}; a signal to control an electrically operated oil pump which is a hydraulic pressure source for generating a hydraulic pressure that is regulated to the line pressure P_{L}; a signal to drive an electric heater; and a signal to be applied to a cruise control computer.

FIG. 4 is the functional block diagram showing major control functions of the electronic control device 54 (indicated by one-dot chain line), which functions as a control device for controlling the power transmitting system 10. Hybrid control means 62 controls the engine 42 to be operated with high efficiency, and controls the first electric motor MG1 so as to optimize a reaction force generated by the first electric motor MG1, for thereby controlling a speed ratio of the differential gear device 44 operated as an electrically controlled continuously variable transmission. For instance, the hybrid control means 62 calculates a target (required) vehicle output at the present running speed V of the vehicle, on the basis of an operation amount A_{CC} of the accelerator pedal used as an operator's required vehicle output, and the vehicle running speed V, and calculates a target total vehicle output on the basis of the calculated target vehicle output and a required amount of generation of an electric energy. The hybrid control means 62 calculates a target engine output (required engine output) P_{ER} to obtain the calculated target total vehicle output, while taking account of a power transmission loss, a load acting on various devices of the vehicle, a power (an assisting torque) generated by the second electric motor MG2, etc. The hybrid control means 62 controls an operating speed N_{E} and a torque T_{E} of the engine 8 so as to obtain the calculated engine output P_{ER}, and the amount of generation of the electric energy by the first electric motor MG1.

The hybrid control means 62 is configured to control the inverter 48 such that the electric energy generated by the first electric motor MG1 is supplied to the electric energy storage device 52 and the second electric motor MG2 through the inverter 48, so that a major portion of the drive force produced by the engine 42 is mechanically transmitted to the central differential mechanism 22, while the remaining portion of the drive force is consumed by the first electric motor MG1 to convert this portion into the electric energy, which is supplied through the inverter 48 to the second electric motor MG2, whereby the second electric motor MG2 is operated with the supplied electric energy, to produce a mechanical energy to be transmitted to the rear wheel drive output shaft 16 through the automatic transmission 24. Thus, the devices relating to the generation of the electric energy and the consumption of the electric energy by the second electric motor MG2 constitute an electric path through which the electric energy generated by conversion of a portion of the drive force of the engine 42 is converted into the mechanical energy. The hybrid control means 62 commands the hydraulic control circuit 59 to shift the automatic transmission 24 to its operating position selected on the basis of the predetermined shifting lines.

The hybrid control means 62 includes engine output control means for functioning to control the output of the engine 42 so as to provide the required output, by controlling the throttle actuator to open and close the electronic throttle valve as a throttle control, and to control the amount and time of the fuel injection by the fuel injecting device into the engine 42 as a fuel injection control, and/or the timing of ignition of the igniter by the ignition device, alone or in combination as an ignition timing control.

The hybrid control means 62 is further configured to establish a motor-drive mode of the vehicle to drive the vehicle with the second electric motor MG2 while the engine 42 is held at rest. In the motor-drive mode, the engine 42 is usually held at rest, so that the drive force of the first drive power source 12 is zeroed. Accordingly, the hybrid control means 62 shifts the automatic transmission 24 to its low-speed position L and operates the second electric motor MG2 to drive the vehicle.

Further, the hybrid control means 62 functions as regenerative control means during a coasting run of the vehicle with the accelerator pedal placed in its non-operated position, or during braking of the vehicle with the foot brake. The regenerative control means controls the second electric motor MG2 to operate as an electric generator driven with a kinetic energy of the vehicle, that is, by a reverse drive force transmitted from the rear wheels 20 toward the engine 42, so that the electric energy storage device 52 is charged with the electric energy generated by the electric generator, namely, the electric energy generated by the second electric motor MG2 supplied to the electric energy storage device 52 through the inverter 48, for thereby improving the fuel economy of the vehicle. This regenerative control is implemented to obtain the amount of regeneration of the electric energy which is set on the basis of an electric energy amount SOC presently stored in the electric energy storage device 52, and a ratio of the regenerative braking force to a hydraulic braking force, which ratio is suitable for obtaining a total braking force corresponding to the amount of operation of a brake pedal.

The hybrid control means 62 is further configured to command drive force distribution changing means 64 to change or control a distribution of the drive force to the front and rear wheels 18, 20, for optimizing the drive force distribution. The drive force distributing changing means 64 includes clutch torque control means 66, first drive power source control means 68 and second drive power source control means 70, and is configured to change the drive force distribution of the power transmitting system 10 to the front and rear wheels 18, 20, according to the running condition of the vehicle.

The clutch torque control means 66 is configured to change the engaging capacity of the clutch device 41 on the basis of a command value received from the drive force distribution means 64. Described in detail, the clutch torque control means 66 changes the engaging capacity of the clutch device 41 by changing the engaging hydraulic pressure of the hydraulic actuator of the clutch device 41. The first drive power source control means 68 is configured to control the output of the engine 42 and the reaction torque of the first electric motor MG1, for changing the drive force generated by the central differential mechanism 22. The second drive power source control means 70 is configured to control the output of the second electric motor MG2, for changing the drive force transmitted to the rear wheel drive output shaft 16.

Thus, the drive force distribution changing means 64 changes the drive force distribution of the running vehicle according to the running condition of the vehicle, by controlling the drive force generated by the first drive power source 12, the drive force generated by the second drive power source 13 and the engaging capacity of the clutch device 41 through the above-described clutch torque control means 66, first drive power source control means 68 and second drive power source control means 70.

Optimum ratio values of the drive force distribution to the front and rear wheels 18, 20 according to different running conditions of the vehicle are predetermined by experimentation or analytical research, on the basis of the wheel speeds, vehicle running speed V, steering angle and total drive force of the vehicle, the gradient and friction coefficient of the roadway surface, etc., and are stored as a map in optimum distribution setting means 72. On the basis of the specific running condition of the vehicle, the optimum distribution setting means 72 determines from time to time the optimum ratio value of the drive force distribution.

Torque capacity calculating means 74 is configured to calculate a transmission torque Tc (engaging capacity) of the clutch device 41, as a target control value of the clutch device 41, on the basis of the drive force distribution ratio set by the optimum distribution setting means 72. A method of calculating the transmission torque Tc on the basis of the ratio of front/rear distribution of the drive force will be described.

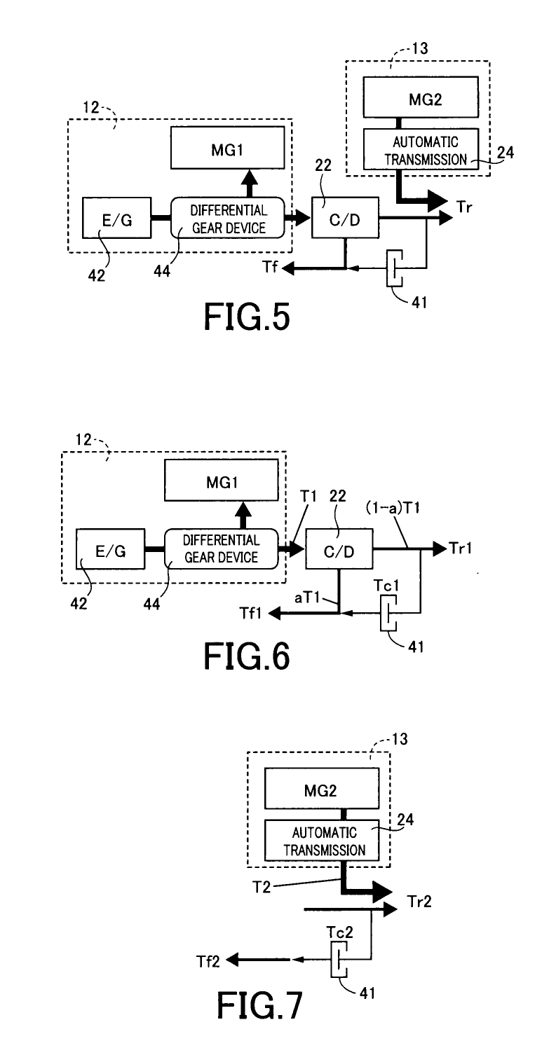

FIG. 5 is the power flow chart indicating a torque transmission relationship of the power source device consisting of the first drive power source 12 and second drive power source 13. In the power source device shown in FIG. 5, the first drive power source 12 generates a first drive power source torque T1, while the second drive power source 13 generates a second drive power source torque T2. The first drive power source torque T1 is mechanically distributed by the central differential mechanism 22 to the front wheel drive output shaft 14 and the rear wheel drive output shaft 16. When the clutch device 41 is placed in the partially engaged state, a portion of the drive force transmitted by the rear wheel drive output shaft 16 is transmitted to the front wheel drive output shaft 14, depending upon the torque capacity (engaging capacity) of the clutch device 41.

FIG. 6 is the power flow chart indicating a torque transmission relationship of the first drive power source 12 and the clutch device 41. In FIG. 6, “T1” represents the first drive power source torque generated by the first drive power source 12, and “a” represents a ratio of the drive force distribution to the front wheels 14 by the central differential mechanism 22, while “Tc1” represents a transmission torque to be transmitted from the rear wheel drive output shaft 16 to the front wheel drive output shaft 14 by the slipping or partial engagement of the clutch device 41. A front wheel torque Tf1 transmitted from the first drive power source 12 to the front wheels 18, and a rear wheel torque Tr1 transmitted from the first drive power source 12 to the rear wheels 20 are respectively represented by the following Equations (1) and (2): The drive force distribution ratio “a” is mechanically determined by the gear ratio of the central differential mechanism 22.

Tf1=aT1+Tc1 Equation (1)

Tr1=(1−a)T1−Tc1 (2)

As is apparent from the Equation (1), a drive force aT1 which is a portion of the first drive power source torque T1 distributed by the central differential mechanism 22, and the transmission torque Tc1 transmitted from the rear wheel drive output shaft 16 through the clutch device 41 are transmitted to the front wheels 18. As is apparent from the Equation (2), on the other hand, a drive force (1−a)T1 which is the remaining portion of the first drive power source torque T1 distributed by the central differential mechanism 22, minus the transmission torque Tc1 transmitted to the front wheels 18 through the clutch device 41, is transmitted to the rear wheels 20.

FIG. 7 is the power flow chart indicating a torque transmission relationship of the second drive power source 13 and the clutch device 41. In FIG. 7, “T2” represents the second drive power source torque generated by the second drive power source 13, and “Tc2” represents a transmission torque to be transmitted from the rear wheel drive output shaft 16 to the front wheel drive output shaft 14 by the slipping or partial engagement of the clutch device 41. A front wheel torque Tf1 transmitted from the second drive power source 13 to the front wheels 18, and a rear wheel torque Tr2 transmitted from the second drive power source 13 to the rear wheels 20 are respectively represented by the following Equations (3) and (4):

Tf2=Tc2 Equation (3)

Tr2=T2−Tc2 Equation (4)

As is apparent from the Equation (3), the transmission torque Tc2 which is a portion of the second drive power source torque T2 transmitted from the rear wheel drive output shaft 16 through the clutch device 41 is transmitted to the front wheels 18. As is apparent from the Equation (4), on the other hand, the second drive power source torque T2 generated by the second drive power source 13, minus the transmission torque Tc2, is transmitted to the rear wheels 20.

It follows from the foregoing explanation that a total drive force of the front wheels 18 and a total drive force of the rear wheels 20 are respectively represented by the following Equations (5) and (6);

Tf=Tf1+Tf2=aT1+(Tc1+Tc2) Equation (5)

Tr=Tr1+Tr2=(1−a)T1+T2−(Tc1+Tc2) Equation (6)

A front wheel drive force ratio tfr of the total drive force Tf of the front wheels 18 to a total vehicle drive force Tt, and a rear wheel drive force ratio trr of the total drive force Tr of the rear wheels 20 to the total vehicle drive force Tt are respectively represented by the following Equations (7) and (8). The total vehicle drive force Tt is a sum of the drive force T1 generated by the first drive power source device 12, and the drive force T2 generated by the second drive power source device 13. The front wheel drive force ratio tfr is the ratio of the total front wheel drive force to the total vehicle drive force Tt generated by the first and second drive power sources 12 and 13, while the rear wheel drive force ratio trr is the ratio of the total rear wheel drive force to the total vehicle drive force Tt.

Tf/Tt=(aT1+(Tc1+Tc2))/(T1+T2) Equation (7)

Tr/Tt=(1−a)T1+T2−(Tc1+Tc2)/(T1+T2) Equation (8)

When the values (Tc1+Tc2), Tf/Tt, and Tr/Tt in the above Equations (7) and (8) are respectively replaced by Tc, tfr and trr, the Equations (7) and (8) are respectively transformed into the following Equations (9) and (10);

tfr=(aT1+Tc)/(T1+T2) Equation (9)

trr=((1−a)T1+T2−Tc)/(T1+T2) Equation (10)

It follows from the Equations (9) and (10) that the transmission torque Tc (=Tc1+Tc2) transmitted through the clutch device 41 is calculated according to the following Equations (11) and (12);

Tc=tfr(T1+T2)−aT1 Equation (11)

Tc=(1−a)T1+T2−trr(T1+T2) Equation (12)

It follows from the foregoing explanation that once a target value of the target front wheel drive force distribution ratio tfr has been set, a target value of the transmission torque Tc of the clutch device 41 can be calculated according to the above Equation 11, and that once the rear wheel drive force distribution ratio trr has been set, the transmission torque Tc can be calculated according to the above Equation (12). Thus, the transmission torque Tc can be calculated according to either of the two Equations indicated above.

The drive force distribution changing means 64 (clutch torque control means 66) controls the engaging torque (torque capacity) of the clutch device 41 so that the calculated transmission torque Tc is transmitted through the clutch device 41. Namely, the drive force distribution changing means 64 controls the engaging hydraulic pressure of the hydraulic actuator of the clutch device 41 such that the engaging torque (torque capacity) of the clutch device 41 is equal to the calculated value of the transmission torque Tc.

The torque distribution calculating means 72 described above is operable also in the motor-drive mode of the vehicle in which the vehicle is driven with only the second drive power source 13 while the engine 42 is held at rest. With the engine 42 being held at rest, the first drive power source torque T1 is zero (T1=0) since the output of the first drive power source 12 is zero. Accordingly, the transmission torque Tc can be calculated according to the Equation (11), to control the drive force distribution to the front wheels 18 in the motor-drive mode, too.

In a regenerative-drive mode of the vehicle in which the second drive power source 13 has a negative output (T2>0), a reverse drive force is transmitted from the rear wheels 20 to the second drive power source 13. In this regenerative-drive mode, too, the transmission torque Tc can be calculated according to the Equation (11) or (12).

As indicated by the Equations (9) and (10), the front wheel drive force distribution ratio tfr and the rear wheel drive force distribution ratio trr are represented with the first drive power source torque T1, second drive power source torque T2 and transmission torque Tc being used as parameters. Therefore, the front wheel drive force distribution ratio tfr and the rear wheel drive force distribution ratio trr are changed over a wide range, by changing the first drive power source torque T1, second drive power source torque T2 and transmission torque Tc. In other words, the drive force distribution has a high degree of freedom. In the released state of the clutch device 41, for example, the transmission torque Tc is zero, so that the front wheel drive force distribution ratio tfr and the rear wheel drive force distribution ratio trr are determined by the first drive power source torque T1 and the second drive power source torque T2. In the partially engaged (slipping) state of the clutch device 41, the front wheel drive force distribution ratio tfr and the rear wheel drive force distribution ratio trr vary with the transmission torque Tc of the clutch device 41, permitting a high degree of freedom of the drive force distribution. Thus, the drive force distribution changing means 64 can control the front wheel drive force distribution ratio tfr and the rear wheel drive force distribution ratio trr to the respective values predetermined depending upon the specific running condition of the vehicle, by controlling the engaging capacity (torque capacity) of the clutch device 41, the drive force of the first drive power source 12 and the drive force of the second drive power source 13 through the clutch torque control means 66, first drive power source control means 68 and second drive power source control means 70, respectively, making it possible to improve the freedom of the drive force distribution.

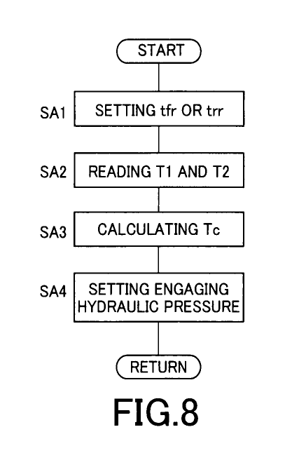

FIG. 8 is the flow chart illustrating a major control function of the electronic control device 54, namely, an operation to calculate the transmission torque Tc that should be transmitted from the clutch device 41. This operation is repeatedly performed with an extremely short cycle time of about several milliseconds to about several tens of milliseconds.

Initially, a step SA1 (“step” being hereinafter omitted) corresponding to the optimum distribution ratio setting means 72 is implemented to set the optimum value of the front wheel drive force distribution ratio tfr or rear wheel drive force distribution ratio trr, on the basis of the running speed V, wheel speeds and steering angle of the vehicle, the gradient of the roadway surface, etc. Then, SA2 corresponding to the hybrid control means 62 is implemented to detect the first drive power source torque T1 generated by the first drive power source 12 and the second drive power source torque T2 generated by the second drive power source 13. Then, SA3 corresponding to the torque distribution calculating means 74 is implemented to calculate a target value of the transmission torque Tc on the basis of the front wheel drive force distribution ratio tfr or rear wheel drive force distribution ratio trr set in the SA1, and the first drive power source torque T1 and second drive power source torque T2 which have been detected in the SA2. Next, SA4 corresponding to the drive force distribution changing means (clutch torque control means 66) is implemented to determine the engaging hydraulic pressure of the hydraulic actuator of the clutch torque 41, on the basis of the transmission torque Tc calculated in the SA3. If the value of the transmission torque Tc calculated on the basis of the front wheel drive force distribution ratio tfr or rear wheel drive force distribution ratio trr cannot be obtained by controlling the engaging hydraulic pressure, it is possible to change the transmission torque Tc to a value that can be obtained, by changing the first drive power source torque T1 or second drive power source torque T2. In this case, it is desirable to minimize an amount of change of the vehicle drive force by preventing a change of the total drive force Tt(=T1+T2).

In the present embodiment described above, the drive force distribution changing means 64 is configured to change the drive force distribution to the front wheel drive output shaft 14 and rear wheel drive output shaft 16, by changing the drive force generated by the second drive power source 13 and the engaging capacity (torque capacity) of the clutch device 41, such that a portion of the drive force T2 generated by the second drive power source 13 is transmitted to the front wheel drive output shaft 14 through the partial (slipping) engagement of the clutch device 41. Further, the drive force distribution changing means 64 makes it possible to improve the freedom of the drive force distribution to the front and rear wheels 18, 20, by changing the drive force T2 generated by the second drive power source 13, as well as the engaging capacity of the clutch device 41.

The present embodiment described above is further arranged such that the drive force distribution changing means 64 changes the drive force distribution to the front wheel drive output shaft 14 and rear wheel drive output shaft 16, by further changing the drive force T1 generated by the first drive power source 12, making it possible to further improve the freedom of the drive force distribution to the front and rear wheels 18, 20.

The present embodiment is further arranged such that the first drive power source 12 includes the engine 42, the first electric motor MG1, and the differential gear device 44 constructed to distribute the output of the engine 42 to the first electric motor MG1 and the power transmitting member 46 (central differential mechanism 22), and functions as an electrically controlled continuously variable transmission capable of continuously changing the speed ratio of the engine 42 with respect to the power transmitting member 46 while the operating state of the first electric motor MG1 is controlled. Accordingly, the drive force transmitted to the power transmitting member 46 (central differential mechanism 22) can be continuously changed.

The present embodiment is further arranged such that the second drive power source 13 is constituted by the second electric motor MG2, so that the drive force of the second drive power source 13 can be continuously changed.

While the preferred embodiment of this invention has been described in detail by reference to the drawings for illustrative purpose only, it is to be understood that the invention may be otherwise embodied.

In the illustrated embodiment, the clutch device 41 is provided with the hydraulic actuator the hydraulic pressure of which is controlled to change the transmission torque Tc. However, the clutch device 41 may be replaced by an electromagnetic clutch device or any clutch device the transmission torque Tc of which is not hydraulically changed.

In the illustrated embodiment, the automatic transmission 24 is operable between the two operating positions consisting of the high-speed position H and the low-speed position L. However, the automatic transmission 24 may be replaced by an automatic transmission having three or more operating positions. Further, the step-variable automatic transmission 24 may be replaced by a continuously variable automatic transmission. The automatic transmission 24 need not be provided, and may be omitted.

In addition, the central differential mechanism 22 provided in the illustrated embodiment, which is constituted by a planetary gear device, may be replaced by any other type of mechanism such as a bevel gear type mechanism.

In the illustrated embodiment, the first drive power source 12 is constituted by the engine 42, first electric motor MG1 and differential gear device 44. However, the first drive power source 12 may use only the engine 42 as a device to generate a drive force, for example. Namely, the drive force output arrangement of the first drive power source 12 is not particularly limited, provided the first drive power source 12 generates a drive force. Accordingly, the first drive power source 12 may employ only an electric motor as a device to generate a drive force.

The illustrated embodiment is arranged to calculate the transmission torque Tc and to control the hydraulic pressure of the hydraulic actuator of the clutch device 41 such that the calculated transmission torque Tc is transmitted through the clutch device 41. It is preferable to change the drive force of the first drive power source 12 and the drive force of the second drive power source 13 additionally if the calculated transmission torque Tc cannot be obtained within a controllable range of the engaging capacity of the clutch device 41, so that the transmission torque Tc falls within the controllable range.

It is to be understood that the embodiment of the invention have been descried for illustrative purpose only, and that the present invention may be embodied with various other changes and modifications which may occur without departing from the spirit of the invention.

1. A control apparatus for a power transmitting system of a four-wheel-drive vehicle, which includes a first drive power source, a second drive power source, and a central differential mechanism disposed between said first and second drive power sources, and wherein the central differential mechanism has an input rotary element and a pair of output rotary elements and is constructed to distribute an output of said first drive power source received by said input rotary element, to said pair of output rotary elements to transmit the output of the first drive power source to front wheels and rear wheels of the vehicle, while said second drive power source is disposed in a power transmitting path between one of said pair of output rotary elements and said front or rear wheels, the control apparatus comprising:
a coupling device disposed between said pair of output rotary elements; and
drive force distribution changing means for changing drive force distribution to said pair of output rotary elements, by changing a drive force generated by said second drive power source and an engaging capacity of said coupling device.

2. The control apparatus according to claim 1, wherein said drive force distribution changing means changes the drive force distribution to said pair of output rotary elements, by further changing a drive force generated by said first drive power source.

3. The control apparatus control apparatus according to claim 1, wherein said first drive power source comprises:
an engine;
a differential electric motor; and
a differential gear device constructed to distribute an output of the engine to said differential electric motor and said input rotary element, and functions as an electrically controlled continuously variable transmission capable of continuously changing a speed ratio of said engine with respect to said input rotary element while an operating state of said differential electric motor is controlled.

4. The control apparatus according to claim 1, wherein said second drive power source is an electric motor.

5. The control apparatus according to claim 1, further comprising optimum distribution ratio setting means for setting an optimum ratio of the drive force distribution to said pair of output rotary elements, according to a running condition of the vehicle.

6. The control apparatus according to claim 5, further comprising torque capacity calculating means for calculating a target value of the engaging capacity of said coupling device, on the basis of the optimum ratio of the drive force distribution set by said optimum distribution ratio setting means, and the drive force generated by said second drive power source.

7. The control apparatus according to claim 6, wherein said drive force distribution changing means includes control means for controlling an actual value of the engaging capacity of said coupling device to said target value calculated by said torque capacity calculating means.
